(19) United States
(12) Patent Application Publication
(10) Pub. No.: US 2026/0356026 A1
(43) Pub. Date: Nov. 12, 2026

(54) METHOD FOR EXTRUDING A MATERIAL USING A MULTI-STAGE EXTRUDER

(71) Applicant: TROESTER GmbH & Co. KG, Hannover (DE)

(72) Inventors: Dennis PREICK, Springe (DE); Wieland HOFFMANN, Hannover (DE)

(21) Appl. No.: 19/333,407

(22) Filed: Sep. 19, 2025

(30) Foreign Application Priority Data
Sep. 20, 2024 (DE) 10 2024 127 170.1

(51) Int. Cl. B29C 48/76; B29C 48/385; B29C 48/92

(52) U.S. Cl. CPC B29C 48/766; B29C 48/385; B29C 48/92; B29C 2948/9259; B29C 2948/92885

(57) ABSTRACT

A method, in which a material is extruded by a multistage extruder, includes plasticizing the material in a first extruder stage; transferring the material to the second extruder stage; bringing the material to a fragmented state via a splitting device; and subjecting the material in the fragmented state to a negative pressure in a negative pressure area of the multistage extruder, so that volatile components and/or trapped gases are at least partly removed from the material. A material flow and/or a mass pressure of the material is automatically adapted by the first extruder stage and/or the second extruder stage such that, at least in normal operation of the multistage extruder, the negative pressure area is filled at most with a predetermined maximum volume of the material that is permissible for the removal of the components and/or gases and/or the fragmented state of the material is maintained.

### CROSS REFERENCE TO RELATED APPLICATIONS

This application claims benefit to German Patent Application No. DE 10 2024 127 170.1, filed on Sep. 20, 2024, which is hereby incorporated by reference herein.

### FIELD

The invention relates to a method in which a material is extruded by means of a multistage extruder comprising at least two extruder stages.

### BACKGROUND

Degassing rubber mixtures containing highly active carbon black can be particularly critical in the rubber industry, in particular during the production of tires and other industrial rubber goods. These rubber mixtures, which are often also designated as TBR Cab mixtures, are applied widely in the production of truck and bus tires. Here, TBR stands for “Truck and Bus Radial”, where they are prized for their excellent properties such as strength and abrasion resistance. The term “Cab” relates to the use of highly active carbon black, i.e. the highly active carbon black already mentioned previously, which contributes to improving the mechanical properties of the mixture.

Because of the chemical properties of rubber mixtures containing carbon black, during the processing with typical preheating it is possible to produce an increased porosity in the extrudate after the extrusion process. This porosity is produced in particular by the liberation of gases and volatile components which can form in the material during the preheating. As a result, this porosity has a negative effect on the properties of tires or other industrial rubber products, in that it impairs the mechanical strength, durability and density of the final products. The nonuniform distribution of gas bubbles can additionally worsen the performance of the material in the following process steps and in the final application, which leads to an increased risk of defects and a shortened lifetime of the products.

Solutions relating to the degassing of plasticized materials are already known in this case from the prior art.

CH 333 283 A describes a method and a device for the continuous mixing, plasticization, degassing and extrusion of materials, in particular plastics, in a single operation. The material mixed and plasticized in a kneader is picked up directly by a discharge screw connected to the kneader, which expels the material continuously through a nozzle. The plasticized material reaches the rectangularly flanged discharge screw intermittently here from the kneader, wherein the intermittent entry is balanced out and the material is conveyed onward under rising pressure. The degassing takes place at a point in the discharge screw which lies downstream of the point at which the material from the kneader enters. Here, the gases can either escape freely or be extracted by a vacuum. At the inlet to the discharge screw, the material is worked intensively, so that volatile materials can escape in gaseous form.

DE 25 43 328 A1 likewise discloses a method and a device for extruding plastics, rubber and other thermoplastics and elastomers, consisting of two screw extruders, in which the first extruder forwards the material to the second. The downstream extruder is equipped with a degassing device in the inlet area and mechanically fixedly connected to the upstream extruder. The feed point in the second extruder is additionally arranged in a central area of this extruder. Between the feed point and the drive of the second extruder there is a screw section which is cut in the extrusion direction and also a screw section which is cut in the opposite direction. In the area of the counter-rotating screw section an outlet is provided for material which has been entrained by the degassing device. This prevents material particles which have arisen as a result of the explosion of bubbles during the degassing and have a relatively long residence time in the extruder from getting back into the material flow. Instead, they are led to the outlet by the counter-rotating screw section.

EP 0 816 048 A1 reveals a further method and a further two-stage extrusion system for extruding rubber mixtures and plastics in an evacuation device arranged between the two stages. In the first extrusion stage, use is made of a gear extruder, while the second stage consists of a screw extruder. The extrudate after the first extrusion stage is finely divided and/or split via a splitting device arranged at the end of the stage or immediately downstream thereof. At the transition to the second extrusion stage, the divided extrudate reaches a space which is connected to a vacuum pump. The divided or split material can either fall through this evacuated space in free fall or is cut off or scraped off the splitting device by the extruder screw of the second stage, additionally picked up by the latter and transferred into the area of the deep screw turns of the screw extruder, this area then being evacuated. The splitting device is designed in particular in the form of a perforated plate in a perforated plate changing device.

The occurrence of porosity of the tires or other industrial rubber goods cannot be avoided continuously via the aforementioned solutions, since the degassing process is highly dependent on the quantity of material in the evacuated space.

### SUMMARY

In an embodiment, the present disclosure provides a method in which a material is extruded by means of a multistage extruder including at least two extruder stages. The method includes plasticizing the material in a first extruder stage of the multistage extruder; transferring the material to the second extruder stage of the multistage extruder; bringing the material to a fragmented state via a splitting device of the multistage extruder; and subjecting the material in the fragmented state to a negative pressure in a negative pressure area of the multistage extruder, so that volatile components and/or trapped gases are at least partly removed from the material. At least a material flow and/or at least a mass pressure of the material is automatically adapted by the first extruder stage and/or the second extruder stage in such a way that, at least in normal operation of the multistage extruder, the negative pressure area is filled at most with a predetermined maximum volume of the material that is permissible for the removal of the components and/or gases and/or the fragmented state of the material is maintained.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of the method and a multistage extruder used for the same; and

FIG. 2 shows a further embodiment of a multistage extruder having a height offset between the extruder stages.

### DETAILED DESCRIPTION

Against this background, embodiments of the present invention ensure that the removal of volatile components and/or trapped gases from the plasticized material can always occur.

Embodiments of the invention relate to a method in which a material is extruded by means of a multistage extruder comprising at least two extruder stages. For this purpose, the material is plasticized in a first extruder stage of the multistage extruder and then transferred to a further extruder stage of the multistage extruder, in addition brought to a fragmented state via a splitting device of the multistage extruder and, in this state, is subjected to a negative pressure in a negative pressure area of the multistage extruder, so that volatile components and/or trapped gases are at least partly removed from the material.

According to an embodiment of the present invention, a method is provided in which a material, for example a plastic, and in a preferred embodiment a rubber mixture, in a particularly preferred embodiment a rubber mixture having added for example highly active carbon black such as a TBR Cab mixture, is extruded by means of a multistage extruder. In a preferred embodiment, the multistage extruder here is a two-stage extruder, for example a tandem extruder. For the extrusion, the multistage extruder according to an embodiment of the invention comprises at least two, but in a preferred embodiment only two, extruder stages. The extruder stages are in a preferred embodiment detachably connected to each other and/or can be moved apart from one another when detached from each other, for example driven apart. Thus, the extruder stages can advantageously be simply cleaned and/or maintained.

According to an embodiment of the invention, provision is additionally made for the material for the extrusion to be firstly plasticized in a first extruder stage of the multistage extruder and then transferred to a further, in a preferred embodiment second, extruder stage of the multistage extruder, for which purpose the material from the first extruder stage would accordingly first be supplied. For example, before, in a preferred embodiment during and/or, for example, after the transfer to the further extruder stage, the material is brought in a manner according to an embodiment of the invention into a fragmented, i.e. split and/or finely divided, state via a splitting device of the multistage extruder and, in this state in a negative pressure area of the multistage extruder, subjected to a negative pressure, in a particular embodiment reduced as compared with a surrounding pressure, in a preferred embodiment an industrial vacuum, so that volatile components and/or trapped gases are at least partly, in a preferred embodiment completely, removed from the material. The material is thus in particular degassed. The negative pressure area here is in a preferred embodiment a transition portion between the first extruder stage and the further, in a particular embodiment second, extruder stage. However, it would likewise be conceivable for the negative pressure area to be formed in a portion of the first extruder stage, i.e. upstream of the transition portion, or a portion of the further extruder stage, i.e. downstream of the transition portion. In addition, the transition portion and a portion of the first extruder stage upstream of the transition portion or a portion of the further extruder stage downstream of the transition portion could also be formed as a negative pressure area. The splitting device can also be designed as a screen or a perforated disk and, for example, be detachably fixed in a holder, in a preferred embodiment a changing device, and/or thus exchangeable. In such a way, the splitting device can be matched to the material to be extruded and, by changing geometric properties of the splitting device, for example a number of holes, a hole spacing and/or a hole diameter, process parameters can be influenced, such as the free surface of the material effected by the fragmentation and/or the counterpressure on the conveyed material caused by the splitting device.

At least a material flow and/or at least a mass pressure of the material through the first extruder stage and/or the further, in a particular embodiment second, extruder stage is additionally adapted automatically according to an embodiment the invention, i.e. in a preferred embodiment subject to open-loop and/or closed-loop control, in such a way that at least in normal operation, including a production mode of the multistage extruder, the negative pressure area is filled at most with a predetermined maximum volume of the material that is permissible for the removal of the components and/or gases and/or the fragmented state of the material is maintained. It is thus ensured that the negative pressure area of the multistage extruder is not inundated by material and volatile components and/or trapped gases are reliably removed from the plasticized material. As a result, porosity in products produced from the extruded material, such as tires or other industrial rubber products, can be avoided, which, in a particular embodiment, ensures the mechanical strength and durability of the products.

In a particularly advantageous embodiment of the invention, the material flow and/or the mass pressure is additionally adapted in such a way that, at least in normal operation of the multistage extruder, at least one sealing area following the negative pressure area directly or indirectly in a conveying direction of the multistage extruder, in a preferred embodiment the further, in a particular embodiment second, conveying stage, in a preferred embodiment in an end portion of the multistage extruder, is filled in such a way that the material in the sealing area seals off the negative pressure area at least with respect to an outlet opening of the multistage extruder, in a preferred embodiment an extrusion die or a mouthpiece. The sealing area is in a preferred embodiment filled completely with material. This likewise contributes to the reliable removal of the volatile components and/or trapped gases from the material since, in this way, in a particular embodiment in combination with further sealing measures, a high negative pressure can be ensured in the negative pressure area.

In an embodiment of the invention, provision is additionally made for the adaptation of the material flow to be carried out at least as a result of the fact that, in a preferred embodiment when and/or as soon as a continuous material flow and/or mass pressure of the material prevails in the sealing area, in a particular embodiment following a transition from a starting operation of the multistage extruder to normal operation, a throughput of the material through the further, in a particular embodiment second, extruder stage is set to a target throughput, in a preferred embodiment under open-loop and/or closed-loop control. Maintaining the target throughput contributes to the stability of the entire extrusion process. The target throughput minimizes the risk of process interruptions or disruptions such as, for example, overfilling, material blockage or undersupply, including in subsequent production steps. The setting of the throughput of the material to the target throughput and also in general is in a particular embodiment carried out by changing a delivery rate, for example by changing a rotational speed of a conveying device of the further, in a particular embodiment second, extruder stage. By way of example, the target throughput can thus be set by a rotational speed of the conveying device of the further extruder stage being brought to a target rotational speed and/or this target rotational speed being approached. Such a conveying device, as in the first extruder stage, can likewise be, for example, an extruder screw or a gear pump or at least one of their extruder gears. Accordingly, there is the possibility that the first extruder stage and/or the second extruder stage is configured as a screw extruder or a gear extruder.

In general, but in a preferred embodiment in conjunction with the preceding embodiment, an embodiment is to be viewed as highly profitable in which the adaptation of the material flow is carried out at least in that, with a continuous material flow and/or mass pressure of the material prevailing in the sealing area, in a particular embodiment following a transition from a starting operation of the multistage extruder to normal operation, a—prevailing—throughput of the material through the first extruder stage is set to a target throughput that is in a particular embodiment reduced with respect to the—prevailing—throughput, the throughput is therefore reduced in particular to the target throughput. In this way, the transfer or the supply of material into the second extruder stage is advantageously controlled. The setting of the throughput to the target throughput can again be made by changing the delivery rate, in a particular embodiment by changing, in a preferred embodiment by reducing, the rotational speed of the conveying device of the first extruder stage. As a result of the targeted reduction in the throughput in the first extruder stage to the target throughput, the transfer or the supply of material into the second extruder stage here can be precisely controlled and/or adapted. Thus, for example, overfilling and/or overloading of the following, further extruder stage can be prevented and a stable material flow can be ensured. Thus, a uniform and needs-based supply of material into the second extruder stage is made possible. This contributes to the processing capacity of the second extruder stage being used optimally, which raises the efficiency of the entire extrusion process.

In a preferred embodiment of the invention, in particular in conjunction with the preceding embodiment, the target throughput of the material through the first extruder stage is set such that in the sealing area a continuous material flow and/or mass pressure of the material still-prevails, but in a conveying area, in a preferred embodiment the further, in a particular embodiment second, extruder stage, upstream of the sealing area and/or downstream of the negative pressure area, there is a discontinuous material flow and/or mass pressure of the material. This highly advantageously leads to the conveying area not being filled completely with material and, as a result, the negative pressure area of the multistage extruder being filled at most with the predetermined maximum volume of the material that is permissible for the removal of the components and/or gases and/or the fragmented state of the material being maintained. As a result of the refinement, the negative pressure area is therefore not inundated with material.

To set and/or determine the target throughput of the material through the first extruder stage, in an embodiment of the invention, a throughput through the first extruder stage is reduced when a continuous material flow and/or a continuous mass pressure of the material occurs and/or prevails in the conveying area. As a result of reducing the throughput, the effect is firstly that the envisaged discontinuous material flow and/or mass pressure is set in the conveying area. However, the throughput could be reduced here to such an extent that this is no longer sufficiently high to set and/or maintain the envisaged continuous mass flow in the sealing area, so that an undesired, discontinuous material flow and/or mass pressure would be established.

Thus, provision is additionally made for the target throughput of the material through the first extruder stage to be set and/or determined in an embodiment of the invention by a throughput of the material through the first extruder stage being increased again after the reduction if a discontinuous material flow and/or mass pressure of the material occurs and/or is present in the sealing area. In a particular embodiment, a throughput that is reduced during the setting of the target throughput for a discontinuous material flow and/or mass pressure in the conveying area to such an extent that a continuous material flow and/or mass pressure of the material in a particular embodiment prevailing in the sealing area changes to a discontinuous material flow and/or a mass pressure of the material can be increased again such that a continuous material flow and/or mass pressure is in a particular embodiment again established. In such a way, a target throughput of the first extruder stage can be set profitably which, in a particular embodiment depending on the target throughput of the further extruder stage, effects a discontinuous material flow and/or mass pressure in the conveying area and a continuous material flow and/or mass pressure in the sealing area.

To set the target throughput, a number of iterations of reducing and increasing the throughput of the material through the first extruder stage can be carried out. In a particular embodiment, the setting of the target throughput can consist in its adjustment, in a preferred embodiment via a control loop.

In a particular embodiment in the preceding connection, an embodiment of the invention is advantageous in which the determined target throughput of the material of the first extruder stage is additionally retained for a further normal operation following a renewed starting operation, i.e. in a particular embodiment for a further production process, and/or in the further normal operation following a renewed starting operation, i.e. in a particular embodiment in a further production process, is at least temporarily set as a throughput of the first extruder stage. Setting the target throughput determined in the preceding normal operation, i.e. in a particular embodiment in the preceding production process, enables either a shorter adjustment time until the target throughput is established in the further normal operation or even the complete omission of such an adjustment time, in a particular embodiment when the same material is extruded again with the same process parameters and/or conditions.

The setting and/or determination of the target throughput can again be carried out by changing a delivery rate, in a particular embodiment by changing, in a particular embodiment reducing, a rotational speed of a conveying device of the first extruder stage to a target rotational speed. By way of example, the target rotational speed can thus be set by a rotational speed of the conveying device of the first extruder stage being reduced until a discontinuous material flow and/or mass pressure prevails in the conveying area and being increased again when a continuous material flow and/or mass pressure of the material in a particular embodiment prevailing in the sealing area changes to a discontinuous material flow and/or a mass pressure of the material, so that a continuous material flow and/or mass pressure is established again.

In a practical embodiment of the invention, at least in a starting operation of the multistage extruder, material is also conveyed through the first extruder stage until a material flow and/or a mass pressure of the material with a nominal throughput prevails in the negative pressure area, in a particular embodiment immediately upstream of the negative pressure area in a conveying direction, and/or in the negative pressure area. This advantageously leads to more efficient utilization of resources and reduces the operating costs.

Furthermore, in an embodiment of the invention, it is envisaged that, at least in the starting operation of the multistage extruder, when a material flow and/or a mass pressure prevails on and/or in the negative pressure area with the nominal throughput, the further, in a particular embodiment second, extruder stage is in a particular embodiment transferred from an idle state to a delivery state and a throughput of the further, in a particular embodiment second, extruder stage is set into a fixed relation relative to the nominal throughput of the first extruder stage. In such a way, firstly stable process conditions can be established, and the extrusion of the material can begin with high quality. In addition, the quantity of reject material in the following normal operation is reduced and the overall efficiency of the extrusion process is raised. Achieving a stable material flow and/or mass pressure additionally permits a flexible and controlled transition from the starting operation to the normal operation.

The invention permits various embodiments. To further illustrate its basic principle, some of these are illustrated in the drawing and will be described below.

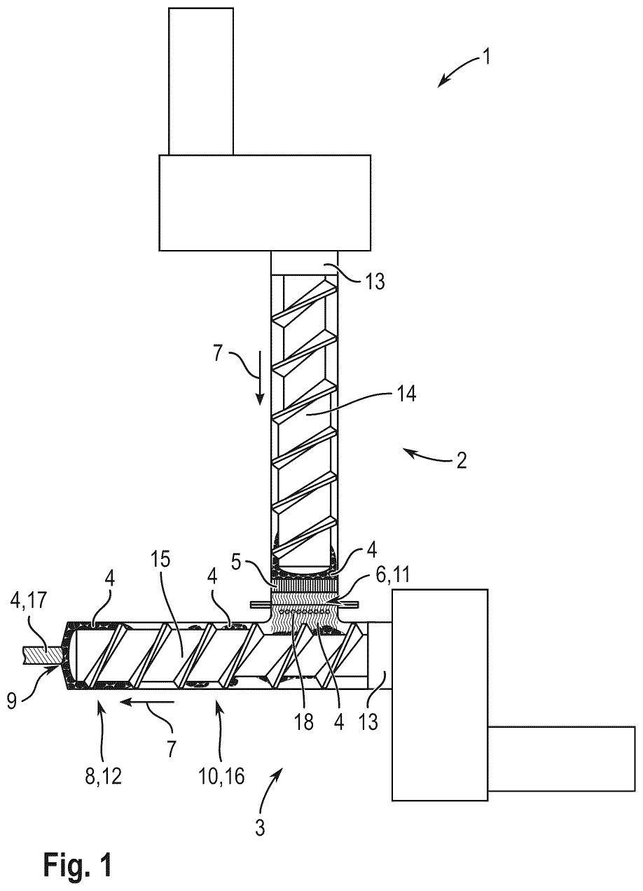

FIG. 1 shows an embodiment of the method according to an embodiment of the invention, wherein the material 4 is extruded by means of the multistage extruder 1, for which purpose the multistage extruder 1 comprises two extruder stages 2, 3. The multistage extruder 1 is thus designed specifically as a two-stage or tandem extruder.

For the extrusion, the material 4 is firstly plasticized in the first extruder stage 2 of the multistage extruder 1 and then transferred to the further, here second, extruder stage 3 of the multistage extruder 1.

In order to avoid porosity of the extrudate 17 from the material 4, here specifically a rubber mixture containing highly active carbon black, volatile components and/or trapped gases are removed from the material 4 during the transition of the material 4 from the first extruder stage 2 to the second extruder stage 3. For this purpose, the multistage extruder 1 has the splitting device 5, which is detachably fastened in the transition portion 11 between the first extruder stage 2 and the second extruder stage 3. The material 4 is brought to a fragmented state via the splitting device 5, a perforated plate in this embodiment of the multistage extruder 1, by being pressed through the splitting device 5 in the conveying direction 7. In this fragmented state, the material 4 in the negative pressure area 6 of the multistage extruder 1, which is formed in the transition portion 11 immediately following the splitting device 5 in the conveying direction 7, is subjected to a negative pressure that is reduced with respect to the surrounding pressure, preferably an industrial vacuum. This is provided via the negative pressure connection 18, which is connected to a negative pressure device, for example a vacuum pump, not specifically illustrated.

In order always to be able to ensure optimal removal of the volatile components and/or trapped gases from the material 4, in particular by avoiding inundating the negative pressure area 6 with material 4, the material flow and/or the mass pressure of the material 4 through the first extruder stage 2 and the further extruder stage 3 is adapted automatically in such a way that, in the normal operation of the multistage extruder 1 illustrated in FIG. 1, a negative pressure area 6 is filled at most with a predetermined maximum volume of the material 4 that is permissible for the removal of the components and/or gases and/or the fragmented state of the material 4 is always maintained.

Furthermore, the material flow and/or the mass pressure of the material 4 through the first extruder stage 2 and the further extruder stage 3 is adapted in such a way that in the normal operation of the multistage extruder 1, the sealing area 8 immediately following the negative pressure area 6 in the conveying direction 7 of the multistage extruder 1 is completely filled, so that the material 4 in the sealing area 8 seals off the negative pressure area 6 at least with respect to the outlet opening 9 of the multistage extruder 1. The sealing area 8 in this embodiment is formed in the end portion 12 of the second extruder stage 3. In addition thereto, both the first extruder stage 2 and the second extruder stage 3 are sealed off in a pressure-tight manner at the respective drive-side bearing 13 of the conveying devices 14, 15 of the extruder stages 2, 3.

In the starting operation of the multistage extruder 1, preceding the normal operation and not specifically illustrated, material 4 is conveyed through the first extruder stage 2, in particular initially until the material flow and/or the mass pressure of the material 4 prevails with a nominal throughput in the negative pressure area 6, here in particular immediately upstream of the negative pressure area 6 in the conveying direction 7. This is carried out by the first extruder stage 2 being changed from an idle state to a conveying state and the delivery rate of the conveying device 14 of the first extruder stage 2, formed as an extruder screw, being changed, increased here. Specifically, this is effected by changing, increasing here, the rotational speed of the conveying device 14, formed as an extruder screw, to a nominal rotational speed.

Then, in the starting operation of the multistage extruder 1 when the material flow and/or the mass pressure prevails in the negative pressure area 6 with the nominal throughput, the further extruder stage 3 is transferred from an idle state to a delivery state and the throughput of the further extruder stage 3 is firstly set into a fixed relation relative to the nominal throughput of the first extruder stage 2. This is once more carried out by the delivery rate of the conveying device 15 of the second extruder stage 3, likewise formed as an extruder screw, being changed, here increased once more, until the rotational speed of the conveying device 15 is in a fixed relation relative to the nominal rotational speed of the conveying device 14 of the first extruder stage 2.

The first extruder stage 2 and the second extruder stage 3 in this embodiment are thus each formed as a screw extruder.

The automated adaptation of the material flow and/or mass pressure of the material 4 is now carried out firstly in that, with a continuous material flow and/or mass pressure of the material 4 prevailing in the sealing area 8 following the transition from the starting operation of the multistage extruder 1 to normal operation, a throughput of the material 4 through the further, here second, extruder stage 3 is set to a target throughput. The target throughput is in turn set by the rotational speed of the conveying device 15 of the further, here second, extruder stage 3 being brought to a target rotational speed and/or this target rotational speed being approached.

The automated adaptation of the material flow and/or mass pressure of the material 4 is also additionally carried out in that, with a continuous material flow and/or mass pressure of the material 4 prevailing in the sealing area 8 in normal operation, the throughput of the material 4 through the first extruder stage 2 is set to a reduced target throughput.

The target throughput of the material 4 through the first extruder stage 2 is firstly set such that in the sealing area 8, as illustrated in FIG. 1, a continuous material flow and/or mass pressure of the material 4 prevails, but, in the conveying area 10 of the multistage extruder 1, which, in the conveying direction 7 of the multistage extruder 1, is formed upstream of the sealing area 8 and downstream of the negative pressure area 6 in the conveying portion 16 of the multistage extruder 1, there is a discontinuous material flow and/or mass pressure of the material 4, as can likewise be gathered from FIG. 1. Specifically, the conveying portion 16 is part of the second extruder stage 3.

In order to achieve this, the target throughput of the material 4 through the first extruder stage 2 is set and/or determined by the throughput through the first extruder stage 2 being reduced when a continuous material flow and/or a continuous mass pressure of the material 4 occurs and/or prevails in the conveying area 10. The throughput of the material 4 through the first extruder stage 2 is additionally increased again following the reduction if a discontinuous material flow and/or a mass pressure of the material 4 occurs and/or is present in the sealing area 8. In such a way, the target throughput can be set, in particular adjusted and determined, in particular over a number of iterations of the reduction and the increase in the throughput of the material 4 through the first extruder stage 2.

The determined target throughput of the material 4 through the first extruder stage 2 is then retained for a further normal operation following a renewed starting operation and/or at least temporarily set as a throughput of the first extruder stage 2 in the further normal operation following the renewed starting operation.

The setting and/or determination of the target throughput is in turn carried out by the rotational speed of the conveying device 14 of the first extruder stage 2 being brought to a target rotational speed, here in particular reduced and/or increased.

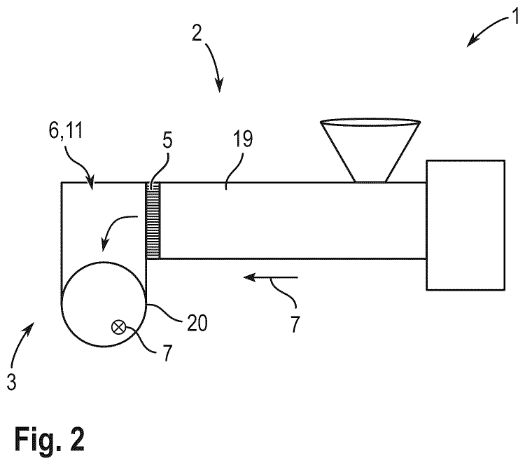

Furthermore, FIG. 2 reveals an embodiment of the multistage extruder 1 which, in turn, is designed as a two-stage extruder having the first extruder stage 2 and the second extruder stage 3. Here, the negative pressure area 6 is again formed in the transition portion 11 following the splitting device 5 in the conveying direction 7, between the first extruder stage 2 and the second extruder stage 3. In this embodiment, the material 4, not specifically illustrated, falls through the negative pressure area 6 at least under the force of gravity during the transfer from the first extruder stage 2 to the second extruder stage 3, since there is a distance in the direction of the vertical axis, i.e. in particular a height difference, between the cylinder 19 of the first extruder stage 2 and the cylinder 20 of the second extruder stage 3. The transfer is indicated by an arrow.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SIGNS

| | |
|---|---|
| 1 | Multistage extruder |
| 2 | Extruder stage |
| 3 | Extruder stage |
| 4 | Material |
| 5 | Splitting device |
| 6 | Negative pressure area |
| 7 | Conveying direction |
| 8 | Sealing area |
| 9 | Outlet opening |
| 10 | Conveying area |
| 11 | Transition portion |
| 12 | End portion |
| 13 | Bearing |
| 14 | Conveying device |
| 15 | Conveying device |
| 16 | Conveying portion |
| 17 | Extrudate |
| 18 | Negative pressure connection |
| 19 | Cylinder |
| 29 | Cylinder |

1. A method in which a material is extruded by means of a multistage extruder comprising at least two extruder stages, the method comprising:
plasticizing the material in a first extruder stage of the multistage extruder;
transferring the material to the second extruder stage of the multistage extruder;
bringing the material to a fragmented state via a splitting device of the multistage extruder; and
subjecting the material in the fragmented state to a negative pressure in a negative pressure area of the multistage extruder, so that volatile components and/or trapped gases are at least partly removed from the material,
wherein at least a material flow or at least a mass pressure of the material is automatically adapted by the first extruder stage or the second extruder stage in such a way that, at least in normal operation of the multistage extruder, the negative pressure area is filled at most with a predetermined maximum volume of the material that is permissible for the removal of the components or gases or the fragmented state of the material is maintained.

2. The method according to claim 1, wherein the material flow or the mass pressure is adapted in such a way that, at least in the normal operation of the multistage extruder, at least one sealing area following the negative pressure area in a conveying direction of the multistage extruder is filled completely in such a way that the material in the at least one sealing area seals off the negative pressure area at least with respect to an outlet opening of the multistage extruder for the material.

3. The method according to claim 1, wherein the automatic adaptation of the material flow or of the mass pressure is carried out at least in that, with a continuous material flow and/or or mass pressure of the material prevailing in at least one sealing area following a transition from a starting operation of the multistage extruder to the normal operation, a throughput of the material through the second extruder stage is set to a target throughput.

4. The method according to claim 1, wherein the automatic adaptation of the material flow and/or or of the mass pressure is carried out at least in that, with a continuous material flow or mass pressure of the material prevailing in at least one sealing area following a transition from a starting operation of the multistage extruder to the normal operation, a throughput of the material through the first extruder stage is set to a reduced target throughput.

5. The method according to claim 1, the wherein a target throughput of the material through the first extruder stage is set such that a continuous material flow or mass pressure of the material prevails in at least one sealing area but there is a discontinuous material flow and/or mass pressure of the material in a conveying area of the multistage extruder upstream of the at least one sealing area or downstream of the negative pressure area in a conveying direction of the multistage extruder.

6. The method according to claim 1, wherein a target throughput of the material through the first extruder stage is set or determined by a throughput through the first extruder stage being reduced if a continuous material flow or a continuous mass pressure of the material occurs or prevails in a conveying area.

7. The method according to claim 1, the wherein a target throughput of the material through the first extruder stage is set or determined by a throughput of the material through the first extruder stage being increased again, following reduction when a discontinuous material flow or a mass pressure of the material occurs or is present in at least one sealing area.

8. The method according to claim 1, wherein a determined target throughput of the material through the first extruder stage is retained for a further normal operation following a renewed starting operation and/or is at least temporarily set as a throughput of the first extruder stage in the further normal operation following the renewed starting operation.

9. The method according to claim 1, the wherein, at least in a starting operation of the multistage extruder, material is conveyed through the first extruder stage until a the material flow or the mass pressure of the material with a nominal throughput prevails in the negative pressure area directly upstream of the negative pressure area in a conveying direction or in the negative pressure area.

10. The method according to claim 1, wherein, at least in a starting operation of the multistage extruder, when a the material flow the mass pressure with a nominal throughput prevails on or in the negative pressure area, the further extruder stage is transferred from an idle state to a delivery state and a throughput of the further extruder stage is at least initially set into a fixed relation relative to the nominal throughput of the first extruder stage.

11. The method according to claim 1, wherein subjecting the material in the fragmented state to the negative pressure further comprises subjecting the material in the fragmented state to an industrial vacuum.
